(19) United States
(12) Patent Application Publication
(10) Pub. No.: US 2014/0172505 A1
(43) Pub. Date: Jun. 19, 2014

(54) METHODS AND SYSTEMS FOR ONLINE SUPPORT AND PROMOTION OF AUTHORS

(71) Applicant: Georgiy Dekhtyaruk, Lutsk (UA)

(72) Inventor: Georgiy Dekhtyaruk, Lutsk (UA)

(21) Appl. No.: 13/833,546

(22) Filed: Mar. 15, 2013

(30) Foreign Application Priority Data
Dec. 13, 2012 (UA) U201214231

(51) Int. Cl. G06Q 30/02

(52) U.S. Cl. CPC G06Q 30/0282
USPC 705/7.32

(57) ABSTRACT

Provided are methods and systems for online support and promotion of authors. Upon allocation of creations to various categories, an author may be supported and promoted by an audience. The audience comprising multiple unregistered users may provide their assessment by viewing and listening to the creations of the author, leaving their comments or making votes. The assessment of the audience may increase a rating of the author or his creations. A high rating may prompt investors to provide a financial support to the author or his creations. The investors may provide the financial support in any amount and within any time period. Based on the financial support, an interest or a fixed amount from future income of the author or his creations may be provided to the investors and a service provider associated with online support and promotion of authors.

### CROSS-REFERENCE TO RELATED APPLICATIONS

This application is Continuation-in-Part of Ukrainian Patent Application No. u201214231, filed on Dec. 13, 2012, which is incorporated herein by reference in its entirety for all purposes.

### FIELD

This application relates generally to methods and systems for marketing and promotion of creations, more specifically, to methods and systems for online support and promotion of authors.

### BACKGROUND

Nowadays, creations of independent authors have a quality rivaling that of professionals. On the one hand, widespread use of Internet exposes authors and their creations to larger audiences. On the other hand, the audience does not have a possibility to participate directly in a formal marketing process on behalf of the authors and usually lacks access to resources enabling to promote and support creations of authors. Direct participation in the formal marketing process is conventionally limited to producers, promotional agencies, advertising agencies, radio stations, and other conventional marketing and distribution means, while many worthy authors usually lack necessary funds to promote their creations.

To raise necessary funds for promotion of their creations, the authors may resort to crowd funding. Crowd funding (alternately crowd financing, equity crowdfunding, social funding or hyper funding) describes the collective effort of individuals who network and pool their resources, usually via the Internet, to support efforts initiated by other people or organizations. Crowd funding is used in support of a wide variety of activities including support of artists by fans, political campaigns, startup company funding, movie or free software development, and scientific research. However, online resources that provide crowd funding opportunities usually offer a limited amount of financial support. A time period within which the financial support needs to be collected may oftentimes be limited as well. Therefore, many talented projects and ideas may just fall short.

Taking into account the aforesaid, the authors need a new fundraising platform which would allow raising unlimited amount of funds within unlimited time period and which would also allow for support and promotion of the authors by the audience.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

Provided are methods and systems for online support and promotion of authors. In general, these methods and systems are designed to support and promote authors and their creations by the public at large.

According to the methods and systems disclosed herein, an author may allocate his creations to different categories, and may then be publically accessible for support and promotion. Multiple different users may view and listen to the creations of the author, leave their comments, or vote for the author or his creations, thereby increasing a rating of the author or his creations. A high rating may attract investors. The investors may provide a financial support to the author or his creations. An amount of the financial support may be unlimited. The financial support may also be provided by the investors within unlimited time period. Based on the financial support, a predetermined amount of income may be provided to the investors and a service provider associated with online support and promotion of authors. The predetermined amount of income may include an interest or a fixed amount from income of the author or his creations.

### BRIEF DESCRIPTION OF DRAWINGS

Embodiments are illustrated by way of example and not limitation in the figures of the accompanying drawings, in which like references indicate similar elements and in which:

FIG. 1 is a block diagram illustrating overall sample environment within which methods and systems for online support and promotion of authors are implemented, in accordance with certain embodiments.

FIG. 2 is a block diagram illustrating an example of the overall system for online support and promotion of authors, in accordance with certain embodiments.

FIG. 3 is a flow chart illustrating a method for online support and promotion of authors, in accordance with certain embodiments.

FIG. 4 illustrates an example of a screen of an author, in accordance with certain embodiments.

FIG. 5 illustrates an example of a screen of an investor, in accordance with certain embodiments.

FIG. 6 illustrates an example of a computer system within which a set of instructions for causing the machine to perform any one or more of the methodologies discussed herein is executed, in accordance with certain embodiments.

### DETAILED DESCRIPTION

The following detailed description includes references to the accompanying drawings, which form a part of the detailed description. The drawings show illustrations in accordance with example embodiments. However, one having ordinary skills in the art would understand that methods and systems described herein may not be limited to these examples and, therefore, are not to be taken in a limiting sense.

Nowadays, different independent authors with various interesting ideas and talented creations seek for a public recognition and professional development.

Systems and methods described herein may allow promoting and supporting authors by the public at large.

According to the methods and systems described herein, a new fully-functional resource may be created. The resource, which may include a service provider associated with online support and promotion of authors, may comprise a plurality of web sites containing various creations of authors. The creations may include artistic works, software, scenarios, graphic presentations, photos, sounds, music, video, audio-visual combinations, interactive functions, or other creations which may be received, provided, viewed, or listened to. An audience comprising multiple different users may search for authors and their creations within the resource. The audience may increase a rating of an author or his creations by viewing, listening, voting, or leaving comments. A high rating of the author or his creations may prompt an investor to provide a financial support. Both the author and the investor may be registered users, while the audience supporting the author or his creations may comprise unregistered users. Furthermore, to attract more public support, the resource or the service provider associated with the online support and promotion of authors may be connected to, associated or otherwise integrated with a social network and contain friend invite features.

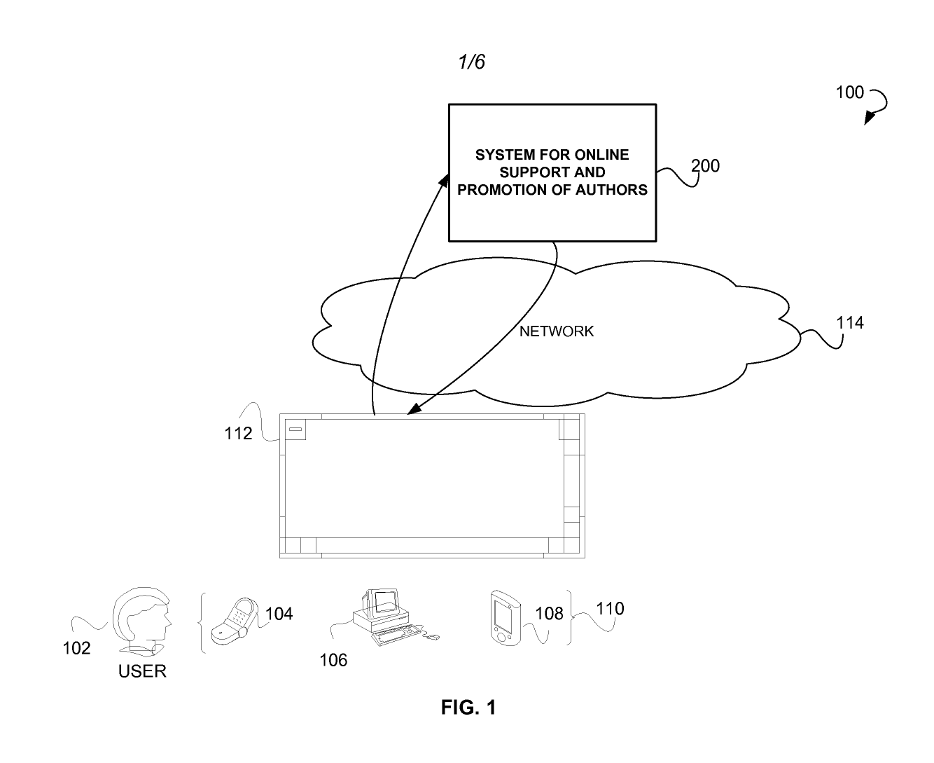

Referring now to figures, FIG. 1 is a block diagram illustrating overall sample environment within which methods and systems for online support and promotion of authors are implemented, in accordance with certain embodiments. As shown in FIG. 1, a user 102 including an author, an investor, or any unregistered user may interact with a system for online support and promotion of authors 200 via client devices 110. The client devices 110 may include a cell phone 104, a computer 106, and a personal digital assistant (PDA) 108.

The client devices 110, in some example embodiments, may include a Graphical User Interface (GUI) for displaying a user interface 112. In a typical GUI, instead of offering only text menus or requiring typed commands, the system presents graphical icons, visual indicators, or special graphical elements called widgets that may be utilized to allow the user 102 to interact with the user interface 112. The client devices 110 may be configured to utilize icons used in conjunction with text, labels, or text navigation to fully represent the information and actions available to users.

The user 102 may periodically provide various information to the system for online support and promotion of authors 200. This information may be stored and processed to create user specific information, such as a profile of the author or the investor. This information may include various demographic information about the user 102 (e.g., age, gender, location, and the like).

The user 102 may interact with the system for online support and promotion of authors 200 via a network 114.

The network 114 may include any type of network capable of communicating data, such as, for example, a wide area network or Internet and/or one or more local area networks (LAN's). The network 114 may also include any suitable number and type of devices, e.g., routers and switches, for forwarding commands, content, and/or web object requests from each client to the online community application and responses back to the clients.

Suitable networks may include or interface with any one or more of, for instance, a local intranet, a PAN (Personal Area Network), a LAN (Local Area Network), a WAN (Wide Area Network), a MAN (Metropolitan Area Network), a virtual private network (VPN), a storage area network (SAN), a frame relay connection, an Advanced Intelligent Network (AIN) connection, a synchronous optical network (SONET) connection, a digital T1, T3, E1 or E3 line, Digital Data Service (DDS) connection, DSL (Digital Subscriber Line) connection, an Ethernet connection, an ISDN (Integrated Services Digital Network) line, a dial-up port such as a V.90, V.34 or V.34bis analog modem connection, a cable modem, an ATM (Asynchronous Transfer Mode) connection, or an FDDI (Fiber Distributed Data Interface) or CDDI (Copper Distributed Data Interface) connection. Furthermore, communications may also include links to any of a variety of wireless networks, including WAP (Wireless Application Protocol), GPRS (General Packet Radio Service), GSM (Global System for Mobile Communication), CDMA (Code Division Multiple Access) or TDMA (Time Division Multiple Access), cellular phone networks, GPS (Global Positioning System), CDPD (cellular digital packet data), RIM (Research in Motion, Limited) duplex paging network, Bluetooth radio, or an IEEE 802.11-based radio frequency network. The network 114 may further include or interface with any one or more of an RS-232 serial connection, an IEEE-1394 (Firewire) connection, a Fiber Channel connection, an IrDA (infrared) port, a SCSI (Small Computer Systems Interface) connection, a USB (Universal Serial Bus) connection or other wired or wireless, digital or analog interface or connection, mesh or Digi® networking. The network 114 may be a network of data processing nodes that are interconnected for the purpose of data communication.

The methods described herein may also be practiced in a wide variety of network environments including, for example, TCP/IP-based networks, telecommunications networks, wireless networks, etc. In addition, the methods described herein may be executed by computer program instructions stored in any type of computer-readable media.

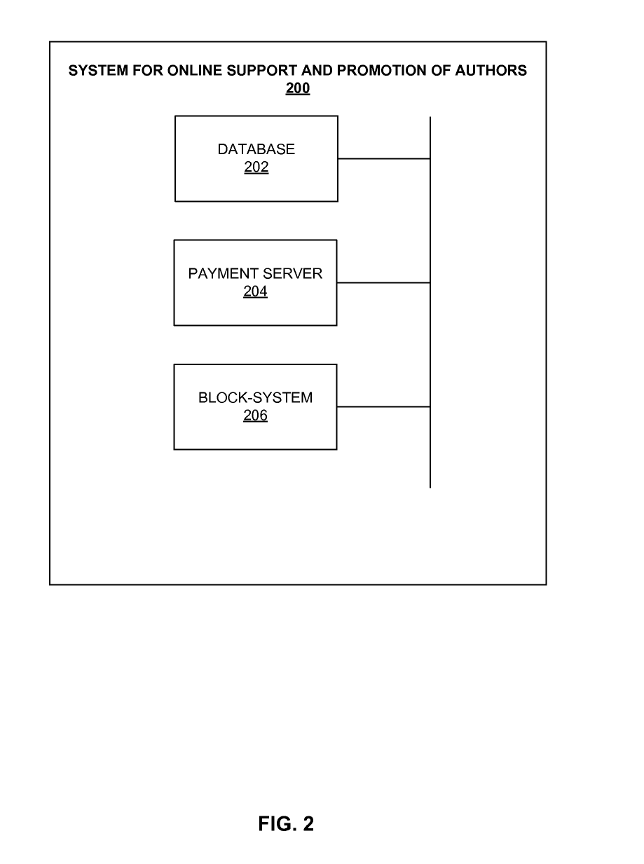

FIG. 2 is a block diagram illustrating an example of the overall system for online support and promotion of authors, in accordance with certain embodiments. Specifically, a system for online support and promotion of authors 200 may include a data base 202 for storing profile data of authors, their creations, and investors. The database 202 may also store information associated with a rating of the authors and their creations.

The system for online support and promotion of authors 200 may further include a payment server 204 for making payment transactions and storing information on a financial support. The financial support may be provided by the investors to the authors using existing online and payment card payment systems, such as PayPal, MasterCard, VISA, American Express, and the like. Accounting, analysis, calculation and performance of transactions may be executed by the payment server 204 according to predetermined algorithms.

In certain embodiments, the system for online support and promotion of authors 200 may additionally include a payment transaction server of a corresponding financial organization.

The system for online support and promotion of authors 200 may further include a block-system 206 for collection and processing of information according to predetermined algorithms.

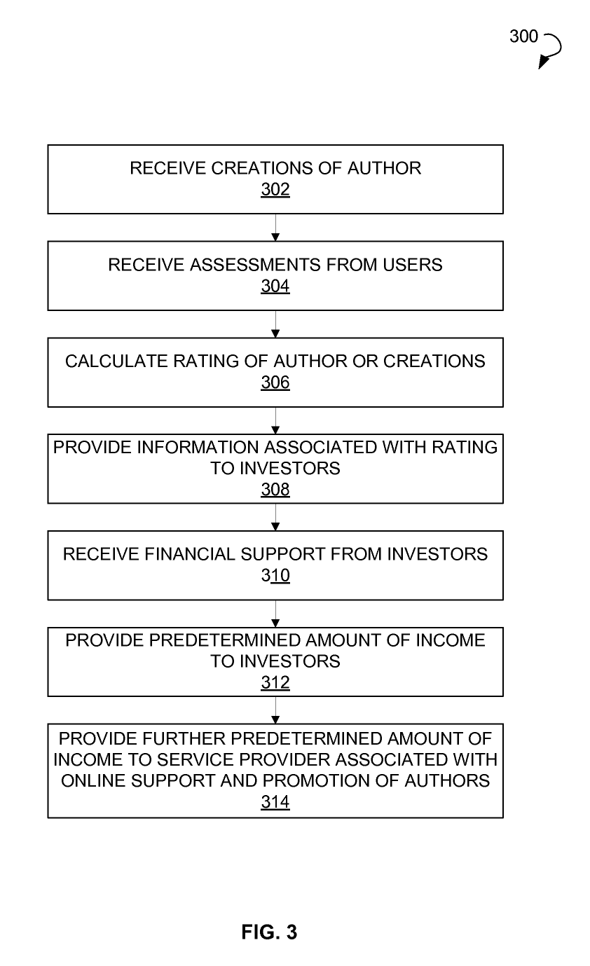

FIG. 3 is a flow chart illustrating a method for online support and promotion of authors, in accordance with certain embodiments.

The method 300 may commence at receiving creations of an author at operation 302. Upon registration, an author may allocate his creations to various categories, such as software, scenarios, graphic presentations, photos, sounds, music, video, audio-visual combinations, interactive functions, and other categories in which the creations of the author may be received, provided, viewed, or listened to. Besides, when registering, the author may be provided with a contract and may grant property rights to his creations to a service provider associated with online support and promotion of authors. The property rights may be granted for a predetermined time period and may be extended by the service provider after expiration of the predetermined time period.

Upon receipt of the creations, the author or his creations may become publically accessibly for support and promotion. Thus, the method 300 may further proceed with receiving assessments from users at operation 304. Multiple different unregistered users may view and/or listen to creations of authors, leave comments, make favorable or unfavorable votes thereby increasing a rating of the author or his creations. Upon receipt of the assessments from the users, the method 300 may further proceed with calculating a rating of an author or his creations at operation 306. The method 300 may then proceed with providing information associated with the rating to investors at operation 308. Upon receipt of the information associated with the rating, the method 300 may proceed with receiving a financial support from the investors at operation 310. The financial support may be provided to the author or his creations. The financial support may not be limited to a fixed amount. A time period within which the financial support may need to be collected may not be limited either. Based on the financial support, the investors may be provided with a predetermined amount of income at operation 312. A further predetermined amount of the income may be provided to the service provider associated with the online support and promotion of authors at operation 314. The predetermined amount of the income may include an interest or a fixed amount from income of the author or his creations.

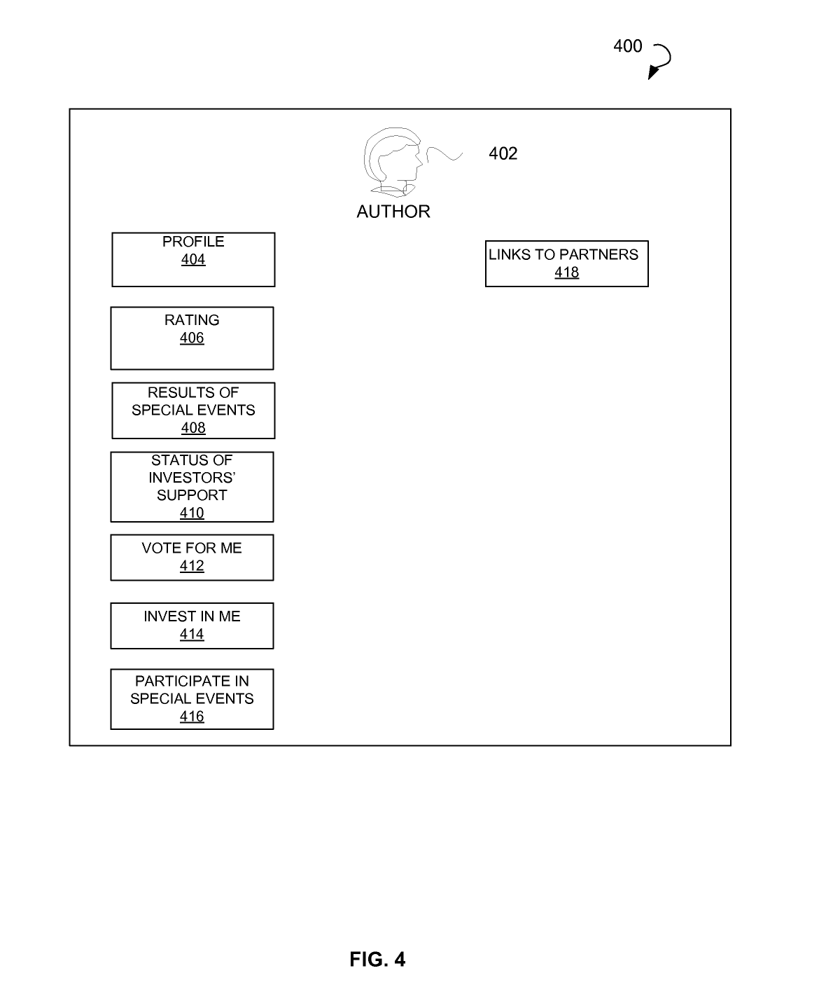

FIG. 4 illustrates an example of a screen of an author, in accordance with certain embodiments. A screen of an author 400 may contain a profile 404. Using the profile 404, an author 402 may deploy various presentations or information to the server. The screen of the author 400 may further contain information associated with a rating 406. In certain embodiments, the author 402 may pay a fee and increase his rating. In certain embodiments, the author 402 may participate in special events and the screen of the author 400 may also contain information associated with results of the special events 408. A financial support provided to the author 402 or his creations may be displayed in a status of investors' support 410. In certain embodiments, the screen of the author 400 may also include the following hidden options: pay a registration fee, integrate a newsfeed and separate fragments of the profile 404 with a social network. In certain embodiments, the screen of the author 400 may also include an individual blog with forum functions and a network group for communication with fans. In certain embodiments, the screen of the author 400 may also contain a special application for a fan club. The special application may include an option to select or add personal statuses. In certain embodiments, the screen of the author 400 may also include a forum for communication between participants of a certain category.

In certain embodiments, using a vote for me option 412 or an invest in me option 414 the author 402 may send an invitation to social networks for his friends to support him. In certain embodiments, the author 402 may also participate in special events and send an invitation for participation to his friends. The invitations may be sent via different social networks connected to, associated or otherwise integrated with a service provider associated with online support and promotion of authors.

In certain embodiments, the author 402 may receive an education course from a partner. The partner may place advertising materials on the screen of the author 400 or on web pages of the service provider associated with the online support and promotion of authors. The advertising materials may include presentations or information associated with education courses. The author 402 may then have an opportunity to take a first free lesson from the partner. The advertising materials may be placed according to two main criteria: advertising fee paid and popularity.

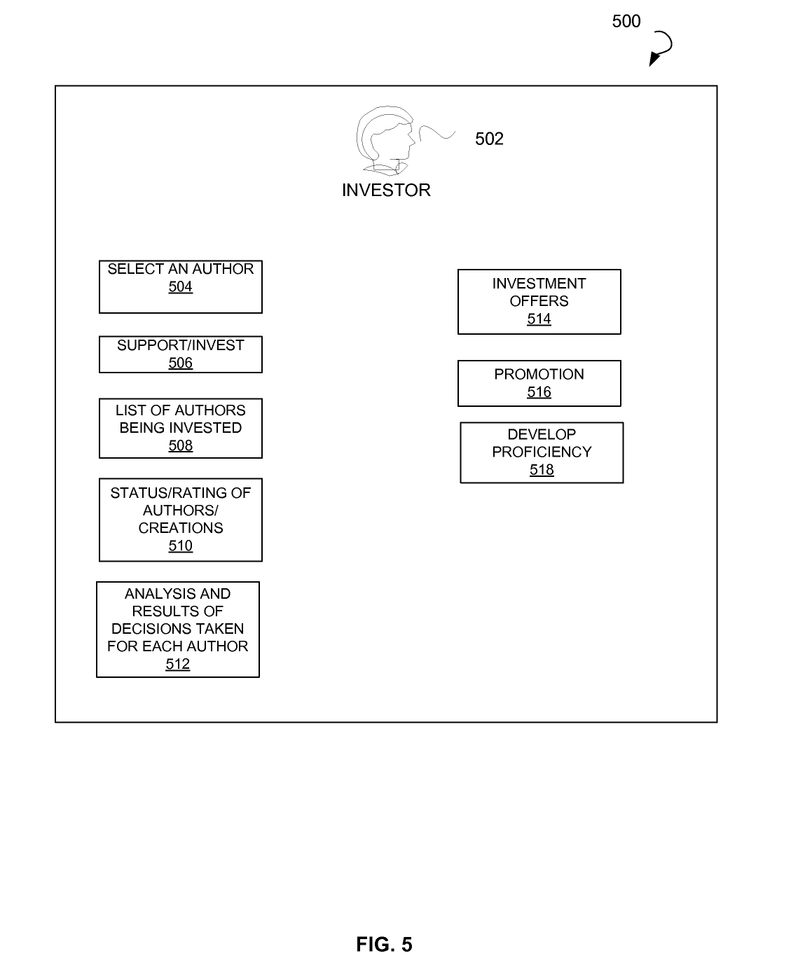

FIG. 5 illustrates an example of a screen of an investor, in accordance with certain embodiments. A screen of an investor 500 may include a select an author option 504. The investor 502 may also support or provide financial support to an author or his creations using a support/invest option 506 which may be connected to, associated or otherwise integrated with a social network. The screen of the investor 500 may also contain statistics, which may include a list of authors being invested 508, a status/rating of authors or their creations 510.

In certain embodiments, the screen of the investor 500 may also include an analysis and results of previous decisions taken for each author 512.

In certain embodiments, the screen of the investor 500 may also include various investment offers options 514.

In certain embodiments, the investor 502 may also use a promotion option 516 to participate in promotion activities to support the author or his creations. The promotion activities may include increasing a rating of the author or his creations by paying a fee, publishing and distributing the creations with a help of partners, nominating the author or his creations, participating in internet sales, PR and advertising activities. Additionally, using a develop proficiency option 518, the investor 502 may pay for courses taken by the author or may support conferences, congresses, symposia, or provide gift certificates.

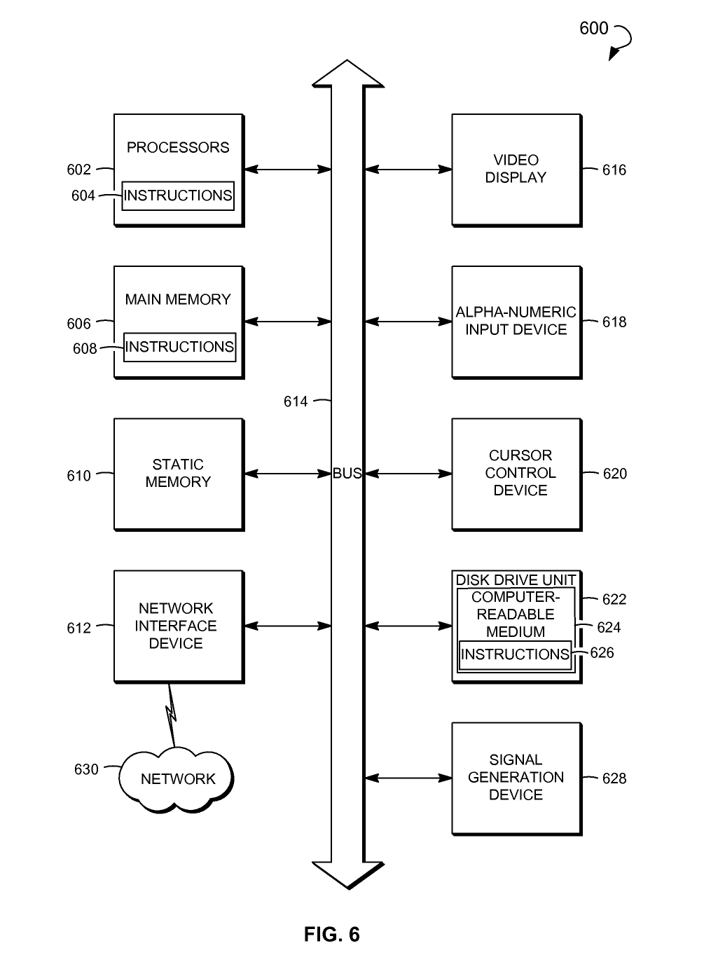

FIG. 6 illustrates an example of a computer system within which a set of instructions for causing the machine to perform any one or more of the methodologies discussed herein is executed, in accordance with certain embodiments. In various example embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a portable music player (e.g., a portable hard drive audio device such as an Moving Picture Experts Group Audio Layer 3 (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

An example computer system 600 includes a processor or multiple processors 602 (e.g., a central processing unit (CPU), a graphics processing unit (GPU), or both), a main memory 606 and a static memory 610, which communicate with each other via a bus 614. The computer system 600 may further include a video display unit 616 (e.g., a liquid crystal display (LCD) or a cathode ray tube (CRT)). The computer system 600 may also include an alphanumeric input device 618 (e.g., a keyboard), a cursor control device 620 (e.g., a mouse), a disk drive unit 622, a signal generation device 628 (e.g., a speaker) and a network interface device 612.

The disk drive unit 622 includes a computer-readable medium 624, on which is stored one or more sets of instructions and data structures (e.g., instructions 626) embodying or utilized by any one or more of the methodologies or functions described herein. The instructions 626 may also reside, completely or at least partially, within the main memory 606 (e.g, instruction 608) and/or within the processors 602 (e.g., instructions 604) during execution thereof by the computer system 600. The main memory 606 and the processors 602 may also constitute machine-readable media.

The instructions 626 may further be transmitted or received over a network 630 via the network interface device 612 utilizing any one of a number of well-known transfer protocols (e.g., Hyper Text Transfer Protocol (HTTP)).

While the computer-readable medium 624 is shown in an example embodiment to be a single medium, the term “computer-readable medium” should be taken to include a single medium or multiple media (e.g., a centralized or distributed database and/or associated caches and servers) that store the one or more sets of instructions executed by the processors 602. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAMs), read only memory (ROMs), and the like.

The example embodiments described herein may be implemented in an operating environment comprising software installed on a computer, in hardware, or in a combination of software and hardware.

What is claimed is:

1. A method for online support and promotion of authors, the method comprising:
receiving one or more creations of an author;
receiving, from one or more users, one or more assessments, the one or more assessments being responsive to the one or more creations or the author;
based on the one or more assessments, calculating a rating of the author or the one or more creations;
providing information associated with the rating to one or more investors;
receiving, from the one or more investors, a financial support for the one or more creations or the author, the financial support being provided in any amount and within any time period;
based on the financial support, providing, to the one or more investors, a predetermined amount of income; and
based on the financial support, providing, to a service provider associated with online support and promotion of authors, a further predetermined amount of income.

2. The method of claim 1, wherein the one or more creations of the author are classified according to one or more categories.

3. The method of claim 1, wherein the author or the one or more creations of the author are publically accessible for support and promotion.

4. The method of claim 1, wherein the one or more assessments include one or more of the following: a view, a comment, a favorable vote, and unfavorable vote.

5. The method of claim 1, further enabling the author to receive an education course from a partner.

6. The method of claim 1, wherein the one or more investors participate in promotion activities to support the author, the promotion activities including one or more of the following: paying a fee, publishing and distributing the creations with a help of partners, nominating the author or his creations, participating in internet sales, PR and advertising activities.

7. The method of claim 1, wherein the service provider associated with the online support and promotion of authors is connected to a social network.

8. The method of claim 1, wherein the financial support is provided using an existing online and payment card payment system.

9. The method of claim 1, wherein the predetermined amount of income associated with the financial support includes one or more of the following: an interest from the income of the author or the one or more creations of the author, and a fixed amount from the income of the author or the one or more creations of the author.

10. The method of claim 1, wherein the author is enabled to grant property rights to the one or more creations to the service provider associated with the online support and promotion of authors, the property rights being granted for a predetermined time period with a possible extension after expiration of the predetermined time period.

11. A system for online support and promotion of authors, the method comprising a processor configured to:
receive one or more creations of an author;
receive, from one or more users, one or more assessments, the one or more assessments being responsive to the one or more creations or the author;
based on the one or more assessments, calculate a rating of the author or the one or more creations;
provide information associated with the rating to one or more investors;
receive, from the one or more investors, a financial support for the one or more creations or the author, the financial support being provided in any amount and within any time period;
based on the financial support, provide, to the one or more investors, a predetermined amount of income; and
based on the financial support, provide, to a service provider associated with online support and promotion of authors, a further predetermined amount of income.

12. The system of claim 11, wherein the one or more creations of the author are classified according to one or more categories.

13. The system of claim 11, wherein the author or the one or more creations of the author are publically accessible for support and promotion.

14. The system of claim 11, wherein the one or more assessments include one or more of the following: a view, a comment, a favorable vote, and unfavorable vote.

15. The system of claim 11, further enabling the author to receive an education course from a partner.

16. The system of claim 11, wherein the service provider associated with the online support and promotion of authors is connected to a social network.

17. The system of claim 11, wherein the financial support is provided using an existing online and payment card payment system.

18. The system of claim 11, wherein the predetermined amount of income associated with the financial support includes one or more of the following: an interest from the income of the author or the one or more creations of the author, and a fixed amount from the income of the author or the one or more creations of the author.

19. The system of claim 11, wherein the author is enabled to grant property rights to the one or more creations to the service provider associated with the online support and promotion of authors, the property rights being granted for a predetermined time period with a possible extension after expiration of the predetermined time period.

20. A computer-readable medium comprising instructions, which when executed by one or more processors, perform the following operations:
receive one or more creations of an author;
receive, from one or more users, one or more assessments, the one or more assessments being responsive to the one or more creations or the author;
based on the one or more assessments, calculate a rating of the author or the one or more creations;
provide information associated with the rating to one or more investors;
receive, from the one or more investors, a financial support for the one or more creations or the author, the financial support being provided in any amount and within any time period;
based on the financial support, provide, to the one or more investors, a predetermined amount of income; and
based on the financial support, provide, to a service provider associated with online support and promotion of authors, a further predetermined amount of income.
